(19) United States
(12) Patent Application Publication
(10) Pub. No.: US 2006/0003606 A1
(43) Pub. Date: Jan. 5, 2006

(54) Signal transmission port structure for computers

(76) Inventors: Chen Wei-Chieh, Taipei (TW); Yu Wen-Lung, Taipei (TW)

Correspondence Address: Yi-Wen Tseng, 4331 Stevens Battle Lane, Fairfax, VA, 22033, US

(21) Appl. No.: 10/879,116

(22) Filed: Jun. 30, 2004

(51) Int. Cl. H01R 12/00

(52) U.S. Cl. 439/65

(57) ABSTRACT

A signal transmission port structure for computers utilized to provide the signal transmission module and the motherboard a “board to board” connection, by which a computer can proceed signal transmission with peripheral devices. The signal transmission port structure includes one or more primary connecting member and one or more secondary connecting member which are mounted correspondingly and respectively on the motherboard or the signal transmission module circuit board. When compared with the conventional art, which requires screwing the signal transmission module onto the chassis and plugging the connectors of ribbon cables into their corresponding receptacles of the motherboard, the present invention is much more convenient for the installation of signal transmission ports and the replacement of electrical components.

### BACKGROUND OF THE INVENTION

The present invention relates in general to a signal transmission ports' means of connection, and more particularly, to a signal transmission port structure for computers wherein various signal transmission ports are incorporated into a signal transmission module, and thereby exempted from using the ribbon cables for connecting to the motherboard.

The design of electrical instruments today, and especially the computer, focuses not only on processing speed and multifunction capability, but also on attaining a compact size and attractive appearance. By modularizing computer parts such as motherboards, electrical elements, signal transmission ports, and other peripheral devices, these parts can be made to fit within the small inner space required by today's computer. The signal transmission ports, especially, can be designed to consume less space within the computer. This is done by modularizing the signal transmission ports which have the purpose of connecting the computer to various external electrical devices or computer peripherals including, USB ports, IEEE ports, microphone jacks, speaker jacks, and RS232 connectors. Once the signal transmission ports have been modularized into a signal transmission module, the signal transmission module can be incorporated into the assembled motherboard.

Currently, the most widely used method for connecting the signal transmission module to the motherboard has been through the use of ribbon cables. After a transmission module has been screwed onto the panel or inner surface of the rear plate of the computer, ribbon cables are then plugged into both the transmission module and the motherboard to establish the desired connection. But this conventional method has at least three drawbacks.

The first drawback is that the installment and the exchange of a signal transmission module are difficult. In order to install the signal transmission module it must be screwed onto the computer chassis and then connected to the motherboard by plugging ribbon cables onto both the signal transmission module and the motherboard. The ribbon cables must further be wrapped to improve thermal dissipation. In order to remove the signal transmission module the ribbon cables must be unwrapped and unplugged from the signal transmission module and the motherboard. Then the signal transmission module must be unscrewed from the computer chassis. Obviously, exchanging the signal transmission module is tedious because it involves both removing an old signal transmission module and installing a new signal transmission module. This procedure is both inconvenient and tiresome for the consumer.

The second drawback is that the ribbon cables impede the needed thermal dissipation within the computer by consuming too much space. Because there is a distance between the pins of the signal transmission module and the pins of the motherboard, ribbon cables are required in order to span this distance to complete a connection. But, in order to ensure that the connection created between the signal transmission module and the motherboard is satisfactory, the ribbon cables supplied are always longer than are necessary. Because of the limited room within the computer chassis, the consumer is forced to arrange the excess cable by either laying it directly onto the motherboard or by hanging it across the inner space of the computer. This ad hoc and unorganized arrangement of the excess cable impedes the air circulation within the computer chassis, which in turn hinders the thermal dissipation needed by the motherboard. Therefore, because the motherboard cannot dissipate heat as efficiently as was intended by its engineers, this impeded air circulation due to the excess ribbon can induce unwanted shutdowns of the computer.

The third drawback is that the ribbon cables could cause signal transmission errors or interruptions. Ribbon cables could cause signal transmission errors or interruptions because the cables may have either, hidden defects created during their manufacturing, or inadvertent fractures created during their wrapping for storage or sale. Both of these problems are not obvious, and would be hard for a consumer to identify. Errors and interruptions caused by defective or fractured ribbon cables in turn cause intermittent malfunctioning that is difficult to troubleshoot. In order to remedy the problem a consumer will waste both time and money.

### BRIEF SUMMARY OF THE INVENTION

The present invention provides a signal transmission port structure for computers, which is utilized to remedy the aforementioned drawbacks: (a) the difficulty of installation and the replacement of a signal transmission module because of using ribbon cables as the connecting means, (b) the thermal dissipation problem caused by the ribbon cables scattered inside the computer, (c) signal transmission errors or interruptions caused by defective ribbon cables.

The signal transmission port structure of the present invention provides a “board to board” connection in order to electrically connect the signal transmission ports to the motherboard without using any ribbon cables or soldering methods. The installation and replacement of the signal transmission ports of the present invention is much easier than the conventional art is.

One feature of the present invention is a “board to board” connecting member which provides a direct connection between the signal transmission module and the motherboard. By utilizing the primary and the secondary connecting member mounted correspondingly and respectively on the motherboard or the signal transmission module circuit board, a computer can output signals to or receive data from various peripheral devices thereof.

In one preferred embodiment, the “board to board” connecting member includes one primary connecting member which employs female connectors, and one secondary connecting member which employs male connectors for conjunction with the female connectors.

In one preferred embodiment, the primary connecting member is mounted on the end surface of the motherboard, while the secondary connecting member is mounted on the signal transmission module circuit board. In other preferred embodiments, the primary connecting member is mounted on the signal transmission module circuit board, while the secondary connecting member is mounted on the end surface of the motherboard.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is a perspective view of a signal transmission module and a computer motherboard, illustrating the usage of the connecting member.

FIG. 2 is a perspective view of a signal transmission module and a computer motherboard, wherein the signal transmission module has been assembled onto the computer motherboard.

FIG. 3 is a side view of a signal transmission module assembled onto a computer motherboard.

FIG. 4 is a side view of a computer motherboard incorporated with a signal transmission module, illustrating that the signal transmission module projects out from a computer front panel or rear plate.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

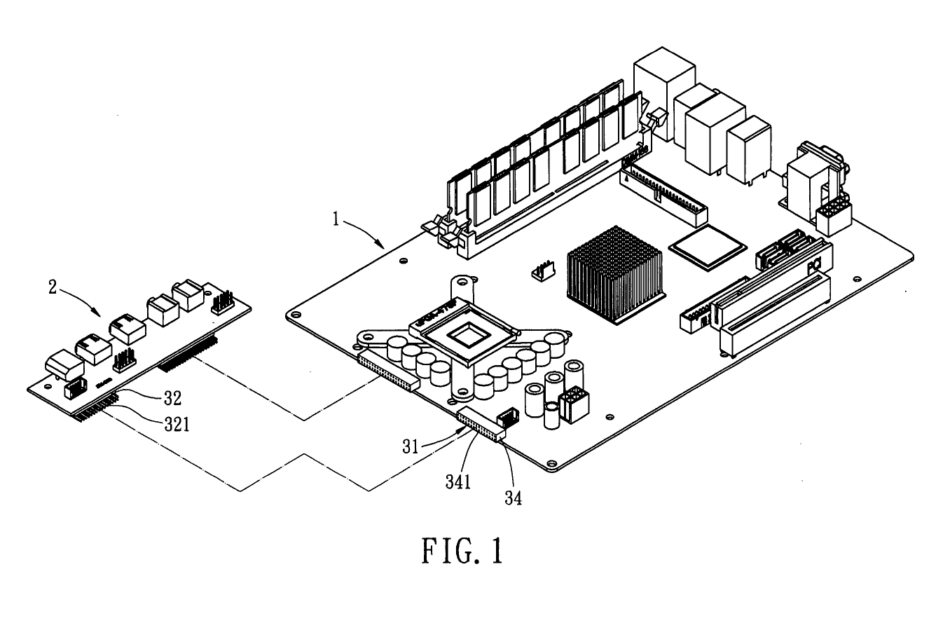

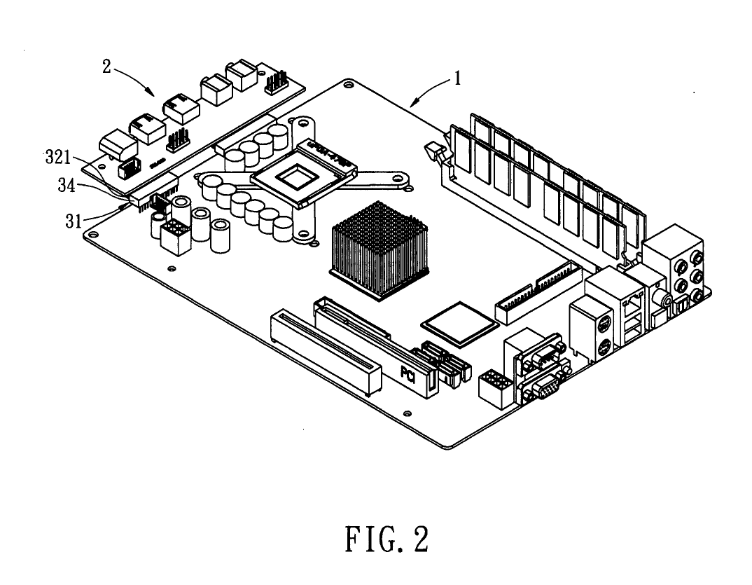

Referring to FIG. 1 through FIG. 3, one embodiment of a signal transmission port structure for the present invention and its application are illustrated. The signal transmission port structure for computer, according to the main technique disclosed in a preferred embodiment of the present invention, provides a “board to board” connection utilized especially to electrically connect the signal transmission module circuit board 2 to the motherboard 1 and to orient the signal transmission module circuit board 2 on the edge of the motherboard 1.

The signal transmission port structure for one preferred embodiment of the present invention is mainly a “board to board” connecting member. The “board to board” connecting member includes one or more primary connecting member 31, and one or more secondary connecting member 32. The primary connecting member 31 is mounted onto the motherboard 1 in order to provide the signal transmission module 2 a means of connecting to the motherboard 1. The motherboard 1 is not limited to the motherboard shown in the present invention. The motherboard 1 could have other specifications.

The primary connecting member 31 is mounted onto the structure of the motherboard 1 and electrically connected to the various output ports which belong to the different functional electrical elements of the motherboard 1. The preferred location of the primary connecting member 31, which is mounted onto the motherboard 1, is adjacent to the front panel or the rear plate of the computer.

In one embodiment, the primary connecting member 31 utilizes female connectors to provide the signal transmission module 2 with electrical connections to the motherboard 1. The primary connecting member 31 comprises connectors 34 which can be auto-inserted onto the motherboard 1 at their designated locations. The connector 34 is both securely mounted and electrically connected to the motherboard 1 by a plurality of pins (not shown). The connector 34 has either slots or holes 341 on its outside face to both connect to the signal transmission module 2, and to orient the signal transmission module 2 at the edge of the motherboard 1.

In other embodiments, the primary connecting member 31 is not limited to using connectors 34 with holes 341 incorporated into it. The primary connecting member 31 may employ male connectors as well. The male connectors can also be both securely mounted and electrically connected to the motherboard 1 by a plurality of pins (not shown). The male connector can also connect the signal transmission module 2 to the motherboard 1.

The secondary connecting member 32 mounted onto the end surface of the signal transmission module circuit board is capable of being assembled onto the primary connecting member 31 in order to complete the “board to board” connection. By utilizing this connection, the signal transmission ports incorporated in the signal transmission module 2 including USB ports, IEEE ports, microphone jacks, speaker jacks, and RS232 connectors are electrically connected to their corresponding input or output port of the various electrical elements of the motherboard 1. Whereby, a computer can output signals to or receive data from various peripherals devices.

The secondary connecting member 32 employs male connectors which have a plurality of extruding pins. The secondary connecting member 32 has a top surface and a bottom surface. On the top surface a plurality of pins protruding therefrom are mounted onto the signal transmission module circuit board in order to secure and connect the connecting member to the circuit board. To connect the secondary connecting member 32 to the primary connecting member 31, a plurality of pins are employed beneath the bottom surface of the secondary connecting member 32 and extruding therefrom.

In other embodiments, the secondary connecting member 32 is not limited to using the aforementioned male connectors. The primary connecting member 31 and the secondary connecting member 32 can be swapped; the primary connecting member 31 can be mounted on the signal transmission module circuit board, while the secondary connecting member 32 is accordingly mounted on the motherboard 1. This configuration can also achieve the same goal of easy combination and good electrical connection.

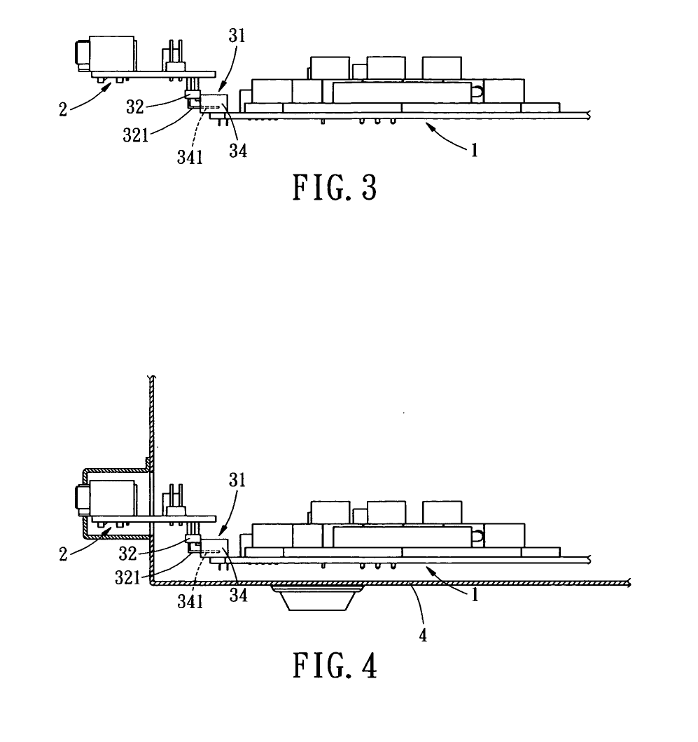

Referring to FIG. 3 and FIG. 4, the signal transmission module 2 being assembled onto the motherboard 1, and together with the motherboard 1 installed inside a computer chassis are illustrated. The signal transmission module 2 can be assembled onto the motherboard 1 before the motherboard 1 being installed into the computer chassis. When compared with the conventional art, which requires screwing the signal transmission module 2 onto the chassis 4 and plugging the connectors of ribbon cables into their corresponding receptacles of the motherboard 1, the present invention is much more convenient for the installation of signal transmission ports and the replacement of electrical components.

The signal transmission module 2, by assembling the secondary connecting member 32 onto the first connecting member 31, not only completes the electrical connection of the signal transmission module 2 and the motherboard 1, but also orients the signal transmission module 2 at the edge of the motherboard 1. Further, the preferred combination is that the signal transmission module 2 projects from the motherboard 1. Thereby, the signal transmission module 2 can be fitted into a corresponding cutout formed on the front panel or the rear plate of the computer for direct use by a consumer.

The signal transmission port structure of the present invention is exempted from using ribbon cables or soldering method for connecting the signal transmission module 2 to the motherboard 1. Consequently, the present invention consumes less computer inner space, and eliminates the possible problems caused by the inferior ribbon cables. It is much easier for the consumer to install or replace the signal transmission module 2.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A signal transmission port structure for computers, comprising:
a computer motherboard;
a signal transmission module formed on a connector board and to be assembled onto the computer motherboard; and
a connecting member providing the connector board to be connected to the computer motherboard without using any ribbon cable or soldering means.

2. The signal transmission port structure of claim 1, wherein the connecting member includes a primary connecting member and a secondary connecting member, the primary and secondary connecting member are employed in a corresponding manner, and wherein the primary connecting member employs a female connector while the secondary connecting member employs a male connector for conjunction with the female connector.

3. The signal transmission port structure of claim 2, wherein the primary connecting member is mounted on the computer motherboard while the secondary connecting member is mounted on the signal transmission module circuit board.

4. The signal transmission port structure of claim 2, wherein the primary connecting member is mounted on the signal transmission module circuit board while the secondary connecting member is mounted on the computer motherboard.

5. A signal transmission port structure for computers, comprising:
a computer motherboard;
a primary connecting member installed on the end surface of the computer motherboard;
a signal transmission module formed on a connector board; and
a secondary connecting member installed on the connector board;
wherein the signal transmission module is assembled to the computer motherboard by connecting the secondary connecting member to the primary connecting member and.

6. The signal transmission port structure of claim 5, wherein the primary connecting member and the secondary connecting member fit to each other and are capable of providing an electrical connection.

7. The signal transmission port structure of claim 5, wherein the primary connecting member is a connector with electricity connecting function.

8. The signal transmission port structure of claim 5, wherein the primary connecting member employs either a female connector or a male connector.

9. The signal transmission port structure of claim 5, wherein the secondary connecting member employs a connector with electricity connecting function.

10. The signal transmission port structure of claim 5, wherein the second connecting member is a male connector or a female connector.
